(19) United States
(12) Patent Application Publication
(10) Pub. No.: US 2017/0132569 A1
(43) Pub. Date: May 11, 2017

(54) RESPONSIVE USER ONBOARDING

(71) Applicant: International Business Machines Corporation, Armonk, NY (US)

(72) Inventors: Prabhuranjan Parhi, Visakhapatnam (IN); Rajesh Patil, Pune (IN); Saraswathi S. Perumalla, Visakhapatnam (IN)

(21) Appl. No.: 14/938,007

(22) Filed: Nov. 11, 2015

(51) Int. Cl. G06Q 10/10; G06F 17/27; G06N 99/00

(52) U.S. Cl. CPC G06Q 10/1053; G06N 99/005; G06F 17/27

(57) ABSTRACT

Onboarding for a new user may be conducted when a system detects a user profile and a role profile, where the role profile is associated with a particular job role within a company. The system may gather learning data about what the user is learning during the onboarding, and send the data to a natural language processing system for analysis. Based on the analysis and the user and role profiles, a next set of onboarding materials may be determined by the system. Based on the next set of onboarding materials and the learning data, the role profile can be updated.

### BACKGROUND

The present disclosure relates to employee onboarding, and more specifically, to responsive new employee onboarding.

Onboarding, or organization socialization, may refer to a mechanism through which new employees acquire knowledge, skills, and behaviors to become organizational members. For example, a new hire at a company may need to be familiarized with concepts such as the structure of the organization, various policies and procedures, and the new hire's professional development plan. The new hire may receive onboarding instruction via formal meetings, lectures, videos, printed materials, computer-based orientations, or formal mentoring.

### SUMMARY

Embodiments of the present disclosure may be directed toward a method where a user profile and a role profile are detected. The role profile may be a profile associated with a particular job role. A system may gather learning data, based on changes in the user profile. The learning data may reflect interactions of the user. The learning data may be analyzed by a natural language processing system. Using the analyzed learning data, the user profile, and the role profile, a next set of onboarding data for the user may be determined. The role profile can then be updated based on the user profile and the determination.

Embodiments of the present disclosure may be directed toward a computing device comprising a computer readable medium with program instructions stored thereon and one or more processors configured to execute the program instructions to perform the method. A user profile may be detected by the system, and a role profile associated with a particular job role may also be detected. The system may then gather learning data from a change in the user profile, where the learning data reflects interactions of a user, where the user is associated with the user profile. The system may analyze the learning data using natural language processing, and determine, based on the role profile, the user profile, and the analyzed learning data, a next set of onboarding data for the user. The system may then update the role profile based on the user profile and the determination.

Embodiments of the present disclosure may be directed toward a computer program product comprising a computer readable storage medium having instructions embodied therewith. The computer readable storage medium is not a transitory signal per se. The program instructions may be executable by a computer processor to cause the processor to perform a method. The method may include detecting both a user profile and a role profile, where the role profile is associated with a particular job role. Learning data may then be gathered from a change in the user profile and it may reflect interactions of a user. The user may be associated with the user profile. The learning data may then be analyzed using a natural language processing system. Based on the role profile, the user profile, and the analyzed learning data, a next set of onboarding data for the user can be determined, and the role profile can be updated based on the user profile and the determination.

The above summary is not intended to describe each illustrated embodiment or every implementation of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 depicts a system diagram for responsively onboarding a new hire, according to embodiments.

FIG. 2 depicts a diagram for compiling a user profile, according to embodiments.

FIG. 3 depicts a flow diagram of a method for updating a role profile, according to embodiments.

FIG. 4 depicts a flow diagram of a method for providing a set of training data to a user, according to embodiments.

FIG. 5 depicts a block diagram of an example natural language processing system configured to ingest and analyze user learning data, according to embodiments.

FIG. 6 depicts the representative major components of an example computer system that may be used, according to embodiments.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the present disclosure relate to employee onboarding, more particular aspects relate to responsive new hire onboarding. While the present disclosure is not necessarily limited to such applications, various aspects of the disclosure may be appreciated through a discussion of various examples using this context.

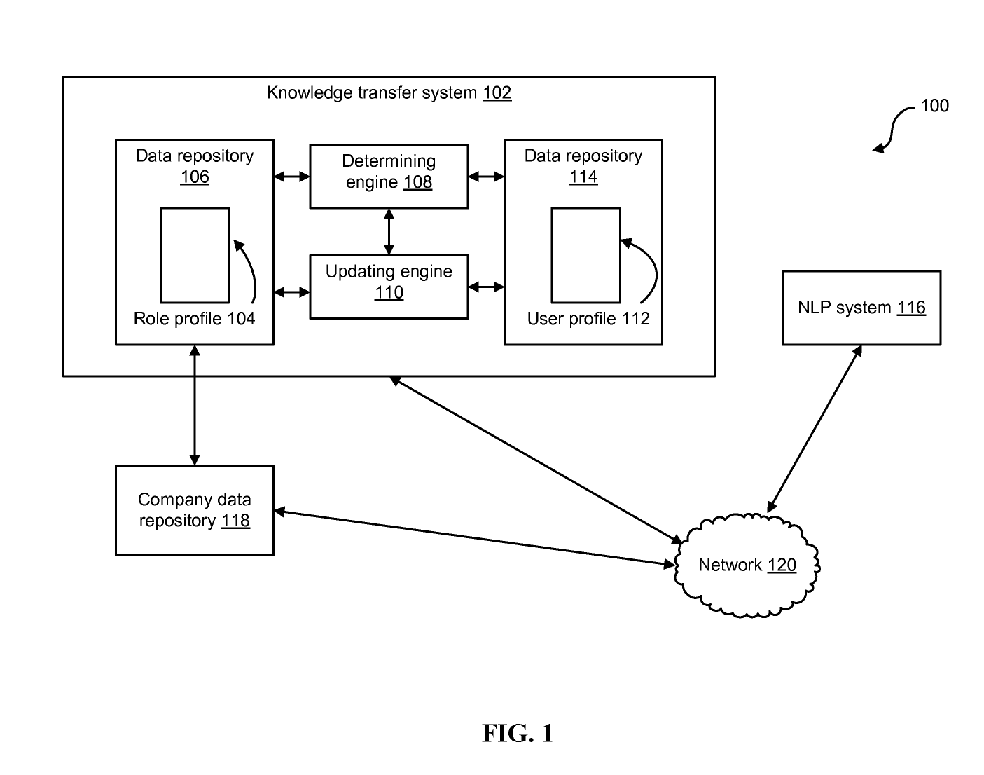

FIG. 1 depicts a system diagram 100 for responsively onboarding a new hire. The system diagram 100 depicts a knowledge transfer system (KTS) 102 in communication with a natural language processing (NLP) system 116, and company data repository 118 over a network 120. In embodiments, the network 120 can include, but are not limited to, local area networks, point-to-point communications, wide area networks, the global Internet, and combinations thereof. In embodiments, the KTS 102 may be a part of a laptop computer, desktop computer, smart phone, a tablet, hosted on a server, or hosted in another way.

The KTS 102 may be used to assist a new hire or other employee in the onboarding or training process. In embodiments, the KTS 102 may comprise one or more engines including a determining engine 108 and an updating engine 110. The KTS 102 may comprise more or fewer engines. The KTS 102 may also comprise a user profile 112 and a role profile 104, each stored within a data repository 114 and 106, respectively. A data repository can be any destination designated for data storage. For example, data storage could include semiconductor storage read-write random-access memory (RAM) (e.g., dynamic-RAM or DRAM), hard drives, optical disk drives, or other non-volatile disk storage. Data may also be stored on non-volatile storage devices (e.g., secondary storage) including flash drives and standalone RAM disks. Data may be a particular group or groups of one or more databases. Data may be partitioned within the data repository based on, for example, security of data. The data repository may be located in physical memory on a user device like a laptop or personal computer, on a server, stored on the cloud, or in another manner. In embodiments, data repositories 106 and 114 hosting the user profile 112 as well as the role profile 104 may be located within the KTS 102. In other embodiments, the data repositories 114 and 106 may be communicatively coupled to the KTS 102. For example, in some embodiments, the KTS 102 may communicate with one or more of the data repositories 106 and 114 to access one or more of the profiles 112 and 104 over the network 120. A data repository may contain more or fewer data structures than those depicted herein.

For example, data repository 106 may store the role profile 104, as well as other role profiles, for different roles within the same or a different company. The data repository could also contain other profiles (e.g., a user profile), or other data. The KTS 102 may assist in onboarding or training of multiple employees for the same or different roles. In these embodiments, the KTS 102 may communicate with multiple user profiles and multiple role profiles, via communicating with one or more data repositories over the network 120. For the sake of clarity, the system as depicted and described here will illustrate a single user being trained for a single role, and thus have a single user profile 112 and a single role profile 104.

In embodiments, the KTS 102 may detect a user profile 112. In embodiments, the user profile may be detected when it is submitted by a user, for example, by entering login credentials. The user profile could also be detected when a new user account is activated within a broader company-wide system, for example, when the user officially accepts an offer and is thus in preparation for onboarding. The user profile could also be detected based on other credentials. The user profile 112 may be contained within a data repository 114. The user profile 112 may contain data about the user including work history data, education data, social network profile data, skills data, and other data relevant to the user's skills and knowledge as related to the role for which the onboarding is being conducted.

In embodiments, the data within user profile 112 may be parsed from user-supplied resources such as the user's resume, cover letter, work profile, letters of recommendation, or other resources. The data may also be sourced from one or more resources associated with the user, but not provided directly by the user, including social media profiles, past work history data, interview summaries, skills tests, or other resources. In embodiments, the system may access, for example, data on social media profiles, based on user-supplied data about the profiles. For example, a user may supply a hyperlink to his LINKEDIN profile, which the system can use to locate the profile. Data can then be extracted from the profile and in some embodiments, sent to the NLP system 116 for analysis.

In embodiments, the system may collect data from social media profiles by searching the Internet and/or a database of social data using identifying information about the user. For example, the system could use the user's name and birth date to search social media profiles, and collect data from the user's FACEBOOK profile and TWITTER feed. This data could be sent to the NLP system 116 for analysis or stored directly in the user profile 112.

Upon detection of the user profile 112, the KTS 102 may access a role profile 104. The role profile 104 may be a data structure contained in a data repository, for example data repository 106. The data of the role profile 104 may include skills and resources necessary for the onboarding new hire to review. The role profile 104 may also contain resources developed by the company or elsewhere to assist the new hire in the onboarding process. The role profile 104 could also include contacts, corporate structure, and other data relevant to the new hire's role within the company. Data contained within the role profile 104 may be provided by the company, via, for example, a company data repository 118.

The data in the company data repository 118 could comprise company resources including training materials and internal social network data. The company data repository 118 could have various security controls, in order to ensure that company resources from the company data repository 118 would be shared with the appropriate personnel during training. The role profile data could also be modified by the KTS 102. For example, the role profile 104 may comprise presentations, lists, documents, or other media which communicate company policies and procedures, professional development plans for the new user, location maps and contacts, initial training documents and schedules, and other data that may be provided to the user at some point in his onboarding process. The aforementioned resources could have been sourced, in part or in whole, from the company data repository 118.

From the user profile 112 and the role profile 104, the KTS 102 can gather learning data for the user associated with the user profile 112. For example, the KTS 102 could gather the data by detecting use and changes in the user profile 112. The KTS 102 could also gather data in response to actions taken within a user account, such internal actions as accessing particular emails, responding to a particular email, instant messaging a coworker, reviewing a first document, completing a quiz following a presentation, or another action associated with the user for which the particular user profile 112 exists. The KTS 102 may then send the learning data to the NLP system 116, over network 120, for analysis. In embodiments, NLP system 116 may be a part of the KTS 102. In others, as depicted here, the NLP system 116 may be an entity separate from the KTS 102.

The NLP system 116 may analyze the learning data, and send the analysis data to the knowledge transfer system 102. The system, for example, the determining engine 108, may then determine, from the analysis data, a first or next set of onboarding data the user should receive, based on the role profile and the learning data. This onboarding data may comprise data from a company's internal and/or social repositories. For example, the system may send, to the NLP system, data from a few emails and an instant messaging conversation the user just accessed and participated in, accordingly. One of the emails may contain login credentials for a portal that the user will access on a daily basis, but has yet to access. The chat conversation may include a question from the user to a more experienced coworker about how to access the portal, using the login credentials.

This data can be analyzed by the NLP system 116 and sent back to, for example, the determining engine 108, of the KTS 102. From the analysis, the determining engine 108 of the KTS 102 may determine that the user should next receive an educational slideshow which will train the user on both how to access as well as navigate the particular portal referenced in the email the user read. The updating engine 110 of the KTS 102 may then update the role profile 104 accordingly, to reflect the training materials determined to be appropriate for the user's next onboarding step.

In embodiments, the updating can occur based on the system detecting a difference between a location on an onboarding training path and the next set of onboarding data for the user. In this case, the location of onboarding data on an onboarding training path may represent the current order of delivery, to the user and for training, as determined by the system. Thus, if the determined next set of onboarding materials differs from the prescribed next set of onboarding materials (as existing in the role profile prior to the update), the role profile may be updated to reflect the change, as determined for the particular user.

In embodiments, the system may also access the determined next set of onboarding data and provide it to the user. In this way, the user's learning and interactions may be monitored in order to provide him with appropriate onboarding materials at a pace helpful to the new hire. Additionally, the role profile may be updated to reflect gaps in knowledge or missing resources that are currently not part of the onboarding process, but perhaps should be added, based on the particular user's experience and the level of training the user has achieved. For example, based on the role profile 104 prior to updates, the system may have been providing the portal access training slideshow on a third day of onboarding for the employee. However, based on updates provided by the particular user's interactions and by the updating engine 110 to the role profile 104, the KTS 102 may provide the slideshow on the afternoon of a first day. In this way, the onboarding experience may be a positive one with time well-utilized for both the current user as well as future new hires onboarding into the same role.

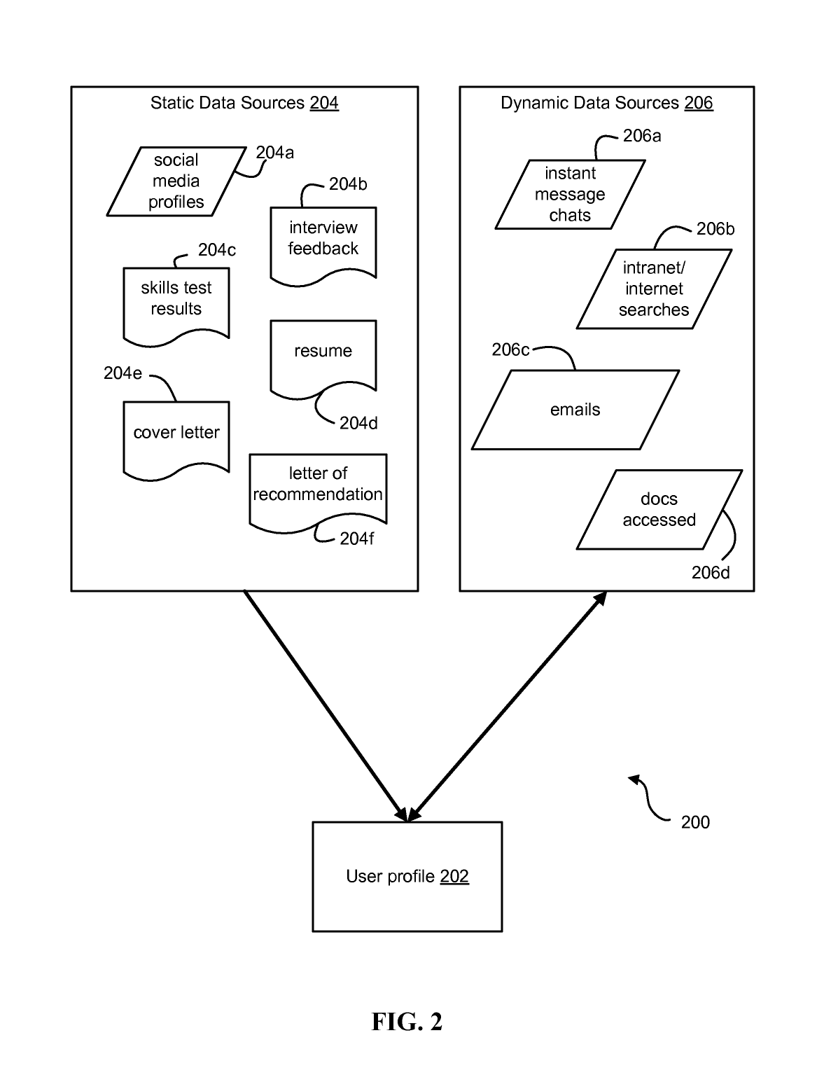

FIG. 2 depicts a diagram 200 for compiling a user profile 202, according to embodiments. The user profile 202 may be the user profile 112 of FIG. 1, and be part of a KTS, for example KTS 102 of FIG. 1. The user profile may be compiled using both static data sources 204 and dynamic data sources 206. For example, static sources of data may be documents or other sources from which data may be sourced to be added to the user profile 112 a single or discrete number of times. This data may come from sources that are static in relation to the user in the course of a few days or weeks of the onboarding process. For example, a resume may be submitted by a user during the user's application process. The resume may be considered a static source of data for the user profile, as the content on the user's resume may not change in the first few days or weeks of the user's onboarding process. The fact that the user's resume may change over the course of a longer period of time (e.g., years) may not be relevant to its characterization as static in this context.

Example static data sources depicted include social media profiles 204a, interview feedback 204b, results from one or more skills or soft skills tests 204c, application materials including a resume 204d and a cover letter 204e, and a letter of recommendation 204f. More or fewer data sources 204 than those depicted may be used in compiling the user profile 202. In some embodiments, data sources characterized as static may be used in the manner of dynamic data sources 206, as described further herein.

Dynamic data sources 206, however, may be sources that can provide changing or dynamic data to the user profile 202 over the course of the user's onboarding process. For example, these sources may comprise data that changes throughout the user's onboarding process, because they monitor the user's use of various tools including instant messaging 206a, emailing 206c, and internet or intranet searches 206b. For example, settings may exist to allow the user or company to set which tools, based on job relevance or other factors, the system may monitor in order to determine which data from dynamic data sources 206 should be collected. In some embodiments, the system may monitor only the company's tools, while others may provide for settings which can be user controlled to provide for a more accurate collection of data relevant to the user profile. Other dynamic data sources may include documents accessed 206d by the user and emails 206c. These sources may provide changing and additional data to the user profile 202 throughout the onboarding process, allowing a KTS—of which the user profile 202 may be a part—to continue to learn about the user as he or she progresses in learning.

For example, on a first day, a user profile may contain a few emails from the user's supervisor and human resources specialist containing welcome messages and initial introductions. This may be supplied to the user profile 202. A day or two later, the user may have sent other emails to his supervisor as well as his administrative assistance, asking about documents needed and tasks completed. The data from these sources may be added to the user profile 202, to be analyzed by an NLP system. From the analysis, the system may determine both that the user has completed a certain number of tasks and is thus at a particular level of learning as well as that one or more documents (e.g., those requested in the email), may be added to the role profile (e.g., role profile 104 of KTS 102 in FIG. 1), as needed by a user onboarding to the specified role earlier than the documents were otherwise being supplied to the user.

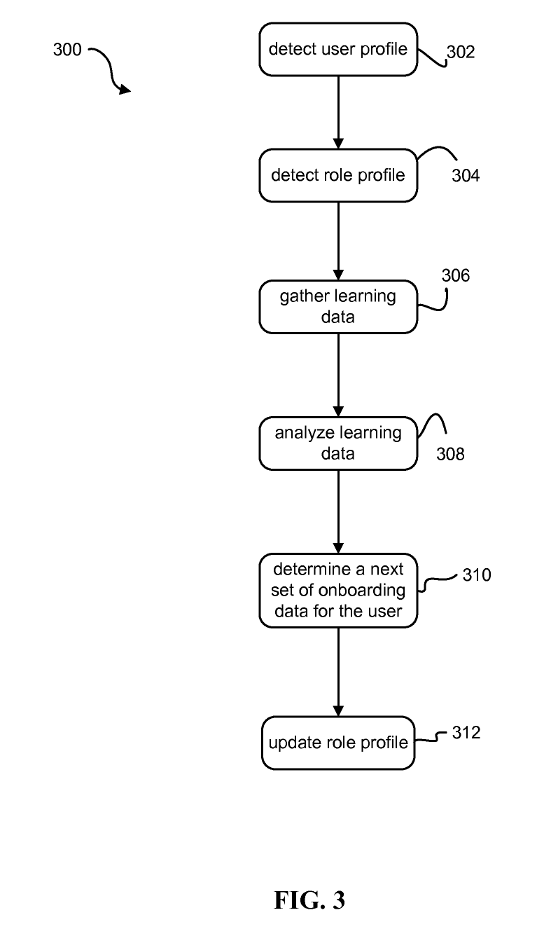

FIG. 3 depicts a flow diagram of a method 300 for updating a role profile, according to embodiments. The method 300 may begin when a system detects a particular user profile, per 302. This user profile may be detectable by the system based on, for example, entry of a user into a particular training or new hire database, activation of a user account, or in another way. Once the user profile is detected, the system may detect a role profile, per 304. The role profile may contain job-specific data, including documents that need to be reviewed, competencies that need to be present, and other data relevant to the role. In some instances, the resources and data that comprise the role profile may be provided by the company for which the user is training, including the user's supervisor, the company's HR department, or another source.

Once both profiles are detected by the system, learning data can be gathered about skills and learning in which the user associated with the user profile has developed or with which the user has engaged, per 306. For example, the learning data could include data collected from one or more dynamic data sources, for example, the dynamic data sources 206 in FIG. 2. The learning data could include data collected from a user's company email account, indicating that the user has accessed (and presumably read), a particular email which contained a particular resource, like an training document for a skill needed by the user in his new role. The learning data can then be analyzed by an NLP system, per 308. In some instances, the NLP system can be a part of the system carrying out the method, or may be an additional system, external to the updating system. In embodiments wherein the NLP system is external, the analyzing the learning data at block 308 may further comprise transmitting the data to an NLP system, for example in the form of an electromagnetic signal, for analysis and receiving the analysis from the NLP system.

Using the analysis of the learning data, combined with data contained within the role profile and user profile, the system can determine the next set of onboarding data for the user, per 310. For example, this may be a set of documents used for training on particular procedures, a presentation on a company protocol, and contact information for the user's first assignment. The system can then update the role profile to reflect the next set of onboarding data for the user, per 312. In this way, the content of the role profile can be refined at each pass, in order to more accurately predict the most intuitive, logical training steps for a particular role. In some embodiments, the determined next set of onboarding data may be provided to the user.

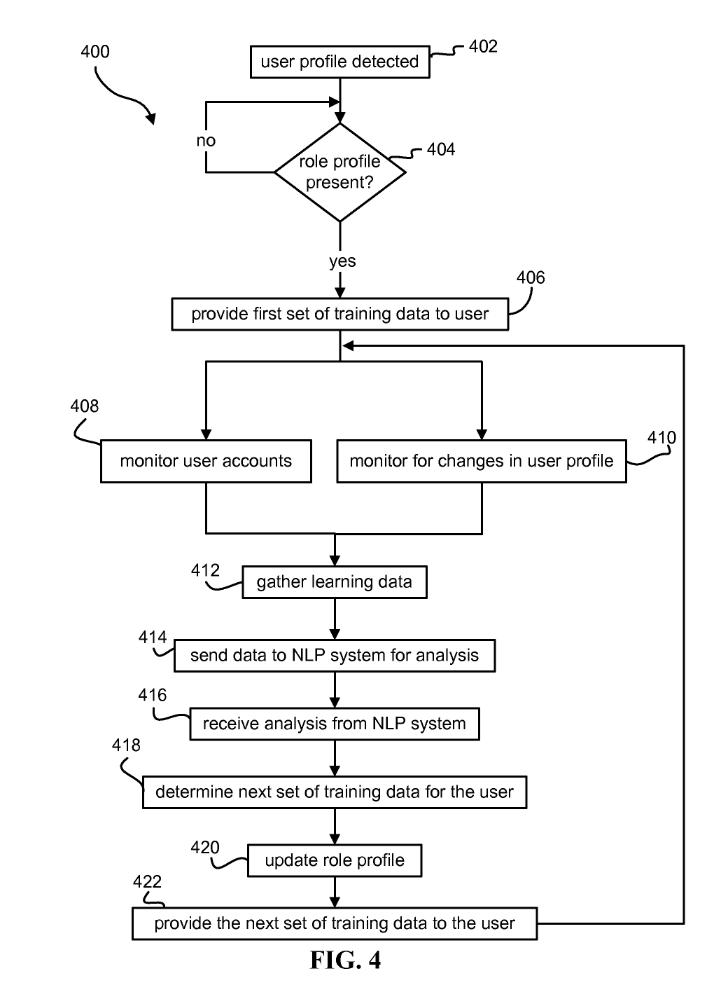

FIG. 4 depicts a flow diagram of a method 400 for providing a set of training data to a user, according to embodiments. The method 400 may begin when a user profile is detected, per 402. For example, the presence of a detectable user profile could indicate that a new user account has been established for a new or an existing user. This new user could be, for example, a new hire needing to complete onboarding for a company and a role, an existing employee moving into a new role within a company, an existing employee needing to continue his education, or a user in another context. The system can then detect whether or not a role profile associated with the user profile is present, per 404. If the role profile is not present, then the system will continue to monitor for a detectable role profile before proceeding with the method 400. If a role profile is detected, the system may provide a first set of training data to the user, based on the user and role profiles, per 406. In some embodiments, training data may not be provided to the user at this early point in the method.

The system may then monitor user accounts, per 408, as well as monitor for changes in the user profile, per 410. From the monitoring, the system can gather learning data, per 412, based on the monitoring at 408 and 410. For example, the system may detect that a user has logged into his email and interacted with a number of colleagues. The content of the emails can be collected as learning data at 412. The learning data can then be analyzed by an NLP system. If the NLP system is external to the updating system, the learning data can be sent to the NLP system, per 414, and received from the system, per 416. Based on the analysis, and in combination with the role profile data and user profile data, the system can determine a next set of training data to the deliver to the user, per 418.

The role profile associated with the user (and for a particular role within the company) can be updated to reflect the determined next set of training data for the user, per 420. In embodiments, that next set of training data can be provided to the user, per 422. The system can then return to monitoring the user account or accounts and for changes in the user profile, per 408 and 410, respectively. This process can continue until the system determines that there is no next set of training data for the user. Upon that determination, the method may end, and the system may disengage from the particular user profile and account.

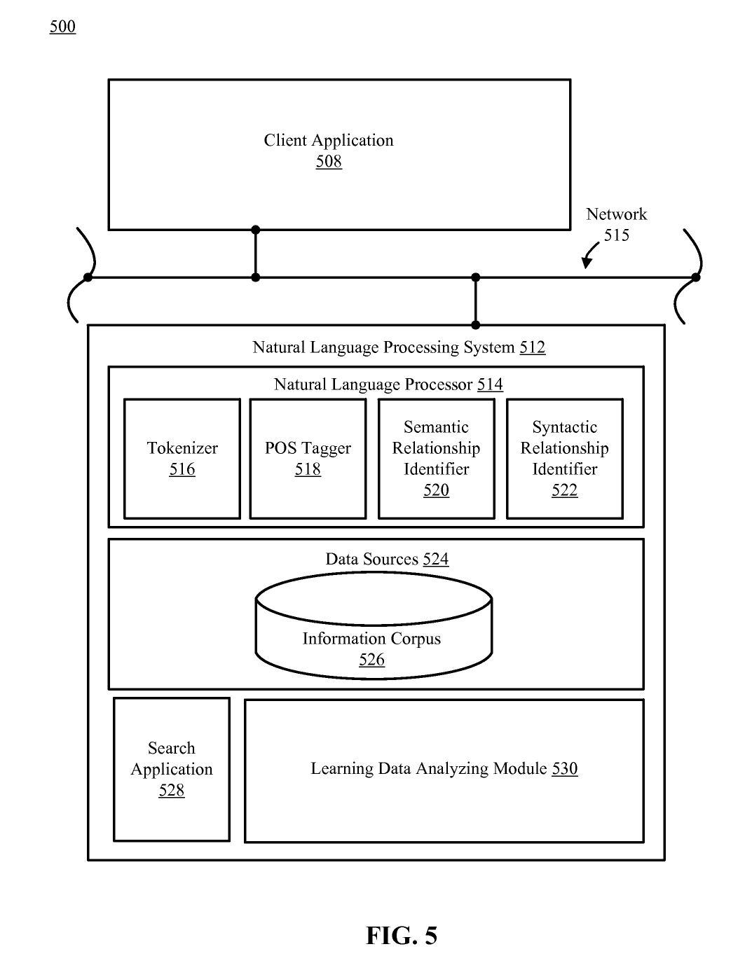

FIG. 5 depicts a block diagram of an example system architecture 500, including a natural language processing system 512, configured to ingest and analyze user learning data, according to embodiments. In some embodiments, a remote device may submit learning data, such as a document that has been read or an email that has been sent, to be analyzed to the natural language processing system 512 which may be housed on a host device. Such a remote device may include a client application 508, which may itself involve one or more entities operable to generate or modify information in the document that is then dispatched to a natural language processing system 512 via a network 515.

Consistent with various embodiments, the natural language processing system 512 may respond to electronic document submissions sent by the client application 508. Specifically, the natural language processing system 512 may analyze a received document to identify information relating to the user's gained learning from the document. In some embodiments, the natural language processing system 512 may include a natural language processor 514, data sources 524, a search application 528, and a learning data analyzing module 530. The natural language processor 514 may be a computer module that analyzes the received documents and other electronic documents. The natural language processor 514 may perform various methods and techniques for analyzing electronic documents (e.g., syntactic analysis, semantic analysis, etc.). The natural language processor 514 may be configured to recognize and analyze any number of natural languages. In some embodiments, the natural language processor 514 may parse passages of the documents. Further, the natural language processor 514 may include various modules to perform analyses of electronic documents. These modules may include, but are not limited to, a tokenizer 516, a part-of-speech (POS) tagger 518, a semantic relationship identifier 520, and a syntactic relationship identifier 522.

In some embodiments, the tokenizer 516 may be a computer module that performs lexical analysis. The tokenizer 516 may convert a sequence of characters into a sequence of tokens. A token may be a string of characters included in an electronic document and categorized as a meaningful symbol. Further, in some embodiments, the tokenizer 516 may identify word boundaries in an electronic document and break any text passages within the document into their component text elements, such as words, multiword tokens, numbers, and punctuation marks. In some embodiments, the tokenizer 516 may receive a string of characters, identify the lexemes in the string, and categorize them into tokens.

Consistent with various embodiments, the POS tagger 518 may be a computer module that marks up a word in passages to correspond to a particular part of speech. The POS tagger 518 may read a passage or other text in natural language and assign a part of speech to each word or other token. The POS tagger 518 may determine the part of speech to which a word (or other text element) corresponds based on the definition of the word and the context of the word. The context of a word may be based on its relationship with adjacent and related words in a phrase, sentence, or paragraph.

In some embodiments, the context of a word may be dependent on one or more previously analyzed electronic documents (e.g., the content of one book may shed light on the meaning of text elements in another book, particularly if they are part of the same corpus or universe). Examples of parts of speech that may be assigned to words include, but are not limited to, nouns, verbs, adjectives, adverbs, and the like. Examples of other part of speech categories that POS tagger 518 may assign include, but are not limited to, comparative or superlative adverbs, wh-adverbs, conjunctions, determiners, negative particles, possessive markers, prepositions, wh-pronouns, and the like. In some embodiments, the POS tagger 518 may tag or otherwise annotate tokens of a passage with part of speech categories. In some embodiments, the POS tagger 518 may tag tokens or words of a passage to be parsed by the natural language processing system 512.

In some embodiments, the semantic relationship identifier 520 may be a computer module that may be configured to identify semantic relationships of recognized text elements (e.g., words, phrases) in documents. In some embodiments, the semantic relationship identifier 520 may determine functional dependencies between entities and other semantic relationships.

Consistent with various embodiments, the syntactic relationship identifier 522 may be a computer module that may be configured to identify syntactic relationships in a passage composed of tokens. The syntactic relationship identifier 522 may determine the grammatical structure of sentences such as, for example, which groups of words are associated as phrases and which word is the subject or object of a verb. The syntactic relationship identifier 522 may conform to formal grammar.

In some embodiments, the natural language processor 514 may be a computer module that may parse a document and generate corresponding data structures for one or more portions of the document. For example, in response to receiving a book at the natural language processing system 512, the natural language processor 214 may output parsed text elements from the book as data structures. In some embodiments, a parsed text element may be represented in the form of a parse tree or other graph structure. To generate the parsed text element, the natural language processor 514 may trigger computer modules 516-522.

In some embodiments, the output of the natural language processor 514 may be stored as an information corpus 526 in one or more data sources 524. In some embodiments, data sources 524 may include data warehouses, information corpora, data models, and document repositories. The information corpus 526 may enable data storage and retrieval. In some embodiments, the information corpus 526 may be a storage mechanism that houses a standardized, consistent, clean, and integrated copy of the ingested and parsed book(s). The information corpus 526 may also include a list of concepts found in the ingested book(s). The data may be sourced from various operational systems. Data stored in the information corpus 526 may be structured in a way to specifically address analytic requirements. For example, the information corpus 526 may store the ingested book(s) as a plurality of narrative blocks to make concept path generation easier. In some embodiments, the information corpus 526 may be a relational database.

In some embodiments, the natural language processing system 512 may include a learning data analyzing module 530. The learning data analyzing module 530 may be a computer module that is configured to provide analysis of the learning data, for example by determining a particular training material for which the user has acquired competency, based on the learning data. In some embodiments, the learning data analyzing module 530 may contain submodules.

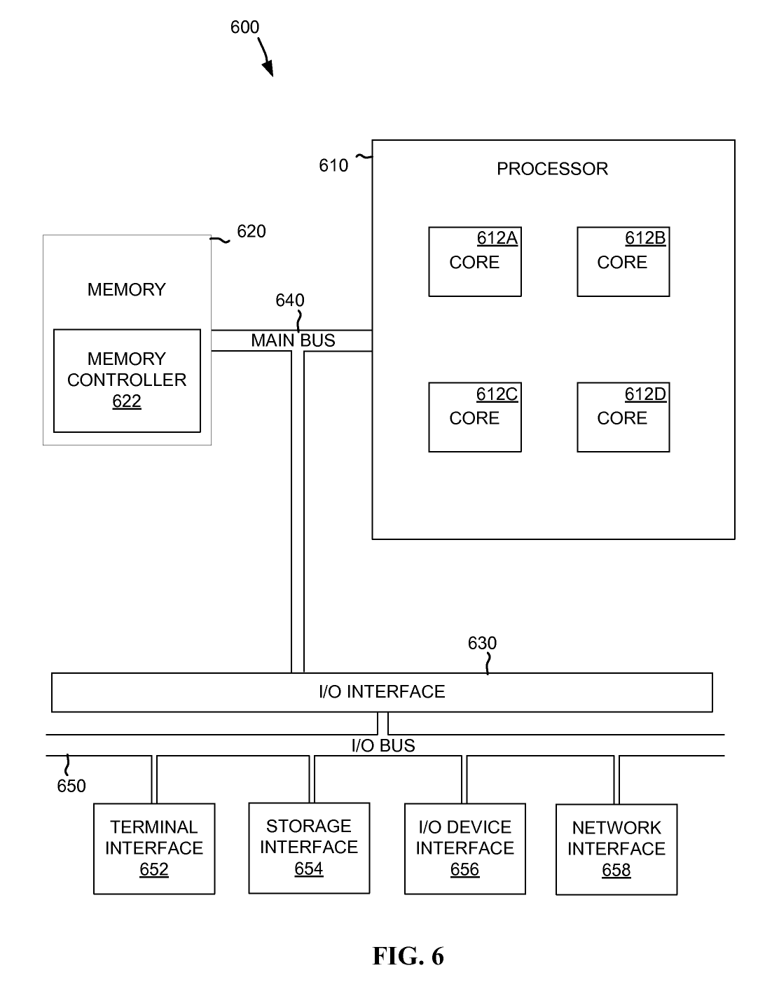

FIG. 6 depicts the representative major components of an example computer system 600 that may be used, according to embodiments. For example, computer system 600 may be a knowledge transfer system, for example knowledge transfer system 102 depicted in FIG. 1. It is appreciated that individual components may vary in complexity, number, type, and\or configuration. The particular examples disclosed are for example purposes only and are not necessarily the only such variations. The computer system 600 may comprise a processor 610, memory 620, an input/output interface (herein I/O or I/O interface) 630, and a main bus 640. The main bus 640 may provide communication pathways for the other components of the computer system 600. In some embodiments, the main bus 640 may connect to other components such as a specialized digital signal processor (not depicted).

The processor 610 of the computer system 600 may be comprised of one or more cores 612A, 612B, 612C, 612D (collectively 612). The processor 610 may additionally include one or more memory buffers or caches (not depicted) that provide temporary storage of instructions and data for the cores 612. The cores 612 may perform instructions on input provided from the caches or from the memory 620 and output the result to caches or the memory. The cores 612 may be comprised of one or more circuits configured to perform one or methods consistent with embodiments of the present disclosure. In some embodiments, the computer system 600 may contain multiple processors 610. In some embodiments, the computer system 600 may be a single processor 610 with a singular core 612.

The memory 620 of the computer system 601 may include a memory controller 622. In some embodiments, the memory 620 may comprise a random-access semiconductor memory, storage device, or storage medium (either volatile or non-volatile) for storing data and programs. In some embodiments, the memory may be in the form of modules (e.g., dual in-line memory modules). The memory controller 622 may communicate with the processor 610, facilitating storage and retrieval of information in the memory 620. The memory controller 622 may communicate with the I/O interface 630, facilitating storage and retrieval of input or output in the memory 620. The memory 620 may contain instructions that are executable by processor 610 to perform methods including methods 300 and 400, as described in FIGS. 3 and 4, respectively.

The I/O interface 630 may comprise an I/O bus 650, a terminal interface 652, a storage interface 654, an I/O device interface 656, and a network interface 658. Display information may be communicated to a display device via I/O device interface 656. The I/O interface 630 may connect the main bus 640 to the I/O bus 650. The I/O interface 630 may direct instructions and data from the processor 610 and memory 620 to the various interfaces of the I/O bus 650. The I/O interface 630 may also direct instructions and data from the various interfaces of the I/O bus 650 to the processor 610 and memory 620. The various interfaces may include the terminal interface 652, the storage interface 654, the I/O device interface 656, and the network interface 658. In some embodiments, the various interfaces may include a subset of the aforementioned interfaces (e.g., an embedded computer system in an industrial application may not include the terminal interface 652 and the storage interface 654). In embodiments, storage interface 654 may be used to access one or more data repositories, including for example, data repositories 106 and 114 of FIG. 1. In embodiments, the storage interface may also access the company data repository 118 of FIG. 1. In other embodiments, the system may access and retrieve data from the company data repository 118, via the network interface 658, and over network 120 of FIG. 1.

Logic modules throughout the computer system 600—including but not limited to the memory 620, the processor 610, and the I/O interface 630—may communicate failures and changes to one or more components to a hypervisor or operating system (not depicted). The hypervisor or the operating system may allocate the various resources available in the computer system 600 and track the location of data in memory 620 and of processes assigned to various cores 612. In embodiments that combine or rearrange elements, aspects and capabilities of the logic modules may be combined or redistributed. These variations would be apparent to one skilled in the art.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. A method comprising:
detecting a user profile;
detecting a role profile, the role profile associated with a particular job role;
gathering, from a change in the user profile, learning data, the learning data reflecting interactions of a user, the user associated with the user profile;
analyzing, using a natural language processing (NLP) system, the learning data;
determining, based on the role profile, the user profile, and the analyzed learning data, a next set of onboarding data for the user; and
updating, based on the user profile and the determining, the role profile.

2. The method of claim 1, further comprising sending, to the user, the next set of onboarding data.

3. The method of claim 1, wherein the user profile comprises data provided by the user.

4. The method of claim 3, wherein the data provided by the user is sourced from a resume, cover letter, and social media profile.

5. The method of claim 1, wherein the user profile comprises data collected from communications of the user.

6. The method of claim 5, wherein the communications of the user comprise email and instant messaging communications.

7. The method of claim 6, wherein the communications are internal communications.

8. The method of claim 1, wherein the next set of onboarding data comprises data from internal and social repositories within a company, the company associated with the particular job role.

9. The method of claim 1, wherein the updating comprises:
detecting, in the role profile, a difference between a location on an onboarding training path and the next set of onboarding data for the user, wherein the next set of onboarding data for the user is associated with the location on the onboarding training path, and wherein the location on the onboarding training path is associated with a particular level of training the user has achieved; and
adding, to the role profile and at the location on the onboarding training path, the next set of onboarding data for the user.

10. A system comprising:
a computer readable storage medium with program instructions stored thereon; and
one or more processors configured to execute the program instructions to perform a method comprising:
detecting a user profile;
detecting a role profile, the role profile associated with a particular job role;
gathering, from a change in the user profile, learning data, the learning data reflecting interactions of a user, the user associated with the user profile;
analyzing, using a natural language processing (NLP) system, the learning data;
determining, based on the role profile, the user profile, and the analyzed learning data, a next set of onboarding data for the user; and
updating, based on the user profile and the determining, the role profile.

11. The system of claim 10, wherein the method further comprises sending, to the user, the next set of onboarding data.

12. The system of claim 10, wherein the user profile comprises data provided by the user.

13. The system of claim 12, wherein the data provided by the user is sourced from a resume, cover letter, and social media profile.

14. The system of claim 10, wherein the user profile comprises data collected from communications of the user.

15. The system of claim 14, wherein the communications of the user comprise email and instant messaging communications.

16. The system of claim 10, wherein the next set of onboarding data comprises data from internal and social repositories within a company, the company associated with the particular job role.

17. The system of claim 10, wherein the updating comprises:
detecting, in the role profile, a difference between a location on an onboarding training path and the next set of onboarding data for the user, wherein the next set of onboarding data for the user is associated with the location on the onboarding training path, and wherein the location on the onboarding training path is associated with a particular level of training the user has achieved; and
adding, to the role profile and at the location on the onboarding training path, the next set of onboarding data for the user.

18. A computer program product comprising a computer readable storage medium having program instructions embodied therewith, wherein the computer readable storage medium is not a transitory signal per se, the program instructions executable by a computer processor to cause the processor to perform a method comprising:
detecting a user profile;
detecting a role profile, the role profile associated with a particular job role;
gathering, from a change in the user profile, learning data, the learning data reflecting interactions of a user, the user associated with the user profile;
analyzing, using a natural language processing (NLP) system, the learning data;
determining, based on the role profile, the user profile, and the analyzed learning data, a next set of onboarding data for the user; and
updating, based on the user profile and the determining, the role profile.

19. The computer program product of claim 18, wherein the method further comprises sending, to the user, the next set of onboarding data.

20. The computer program product of claim 18, wherein the updating comprises:
detecting, in the role profile, a difference between a location on an onboarding training path and the next set of onboarding data for the user, wherein the next set of onboarding data for the user is associated with the location on the onboarding training path, and wherein the location on the onboarding training path is associated with a particular level of training the user has achieved; and
adding, to the role profile and at the location on the onboarding training path, the next set of onboarding data for the user.
